(19) United States
(12) Patent Application Publication
(10) Pub. No.: US 2007/0062636 A1
(43) Pub. Date: Mar. 22, 2007

(54) Media gap detection by reflective florescence

(76) Inventors: Peter Gustafsson, Kallered (SE); Mats Hedberg, Varberg (SE)

Correspondence Address: Orum & Roth LLC, Ste 1616, 53 W Jackson Blvd, Chicago, IL, 60604, US

(21) Appl. No.: 11/365,479

(22) Filed: Mar. 1, 2006

Related U.S. Application Data
(60) Provisional application No. 60/658,059, filed on Mar. 1, 2005.

(51) Int. Cl. B29C 47/00

(52) U.S. Cl. 156/244.16

(57) ABSTRACT

A method of gap detection between successive adhesive layers on a media carrier using reflective florescence. Roll of label media is obtained and placed on a printer (not shown). Labels pass by a UV light source and labels and carrier reflect back a portion of the UV light. The reflected light is detected by a photosensor. The difference in florescence between label and carrier is detected. Location of the change of florescence identifies the location of the beginning of gap/end of label or the end of gap/beginning of label. The printer is adjusted if necessary to ensure any markings, printing, logos, symbologies or other indicia is printed in the correct position on label.

This application claims the benefit of U.S. Provisional Application No. 60/658,059 filed 1 Mar. 2005 entitled Media Gap Detection by Reflective Florescence.

### BACKGROUND OF THE INVENTION

1. Field of Invention

The present invention relates to a reflective florescence used for gap detection of adhesive labels on a media carrier.

2. Description of Related Art

Current methods to detect gaps use transparency differences between the label and the carrier. The transparency difference between label and carrier must be large enough to be accurately detected, resulting in a minimum thickness of label and a maximum thickness of carrier.

There is a need for a method of gap detection that allows for a larger variety of labels to be manufactured without the restrictions created by current gap detection techniques.

### SUMMARY OF THE INVENTION

The present invention is a method of gap detection between successive adhesive layers on a media carrier using reflective florescence. Roll of label media is obtained and placed on a printer (not shown). Labels pass by a UV light source and labels and carrier reflect back a portion of the UV light. The reflected light is detected by a photosensor. The difference in florescence between label and carrier is detected. Location of the change of florescence identifies the location of the beginning of gap/end of label or the end of gap/beginning of label. The printer is adjusted if necessary to ensure any markings, printing, logos, symbolizes or other indicate is printed in the correct position on label.

Media thickness of both the label and the carrier can be reduced, thus increasing number of labels that can be wound on a roll. In addition, carrier quality can be reduced as transparency is not used. This allows use of recycled paper for carrier material.

### BRIEF DESCRIPTION OF THE DRAWINGS

FIG. 1 is a flow chart of the inventive gap detection method.

FIG. 2 is a schematic of the gap detection system.

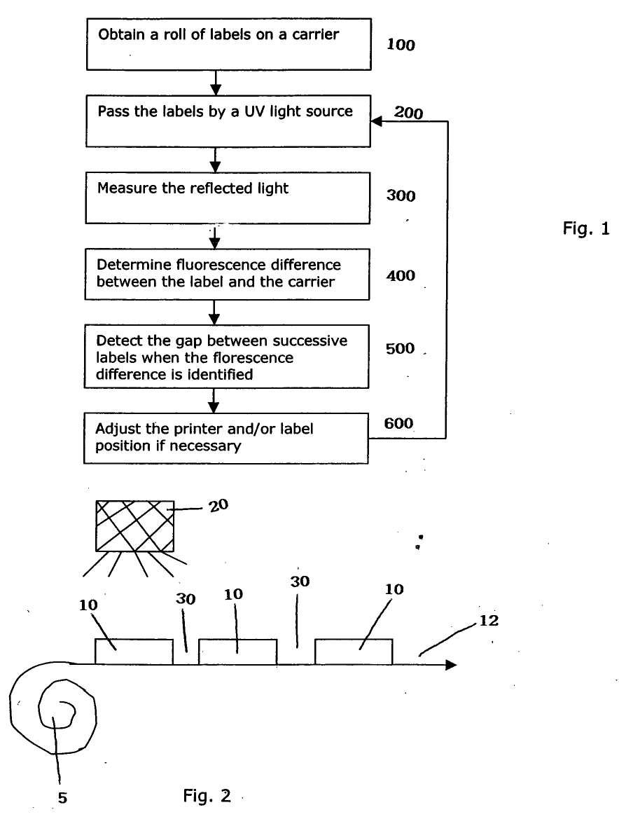

### DETAILED DESCRIPTION OF THE INVENTION

Labels 10 are typically cladded with a chalk and kaolin mixture to enhance the apparent whiteness of paper. This mixture also has a high degree of florescence. A UV-emitting source is preferably combined with a visual light sensitive detector. Combined light source 20 illuminates labels 10 and carrier 12 with UV light and measures the reflected light of a media 10, 12 passing the detector. Alternatively, a light source and a separate detector could be used. The florescence difference between cladded/coated label 10 and un-cladded/uncoated carrier 12 causes a reflective light difference in the visual spectrum which is identified by detector 20 and used for to determine the location of gap 30 and/or of label 10. UV emitting light source is preferably a light emitting diode light source. The visual light sensitive detector preferably utilizes a phototransistor to measure reflected light. Typically, label roll 5 comprises a plurality of labels 10 on carrier 12. There is gap 30 between each successive label 10. A roll of labels 5 is placed on a printer (not shown). Media 10, 12 pass by a UV light source 20 and are illuminated by UV light. A visual light sensitive detector 20 measures the light reflected by media 10, 12. Detector 20 measures the florescence or reflectivity difference between labels 10 and carrier 12. Thus, gaps 30 between successive labels 10 and/or the position of each successive label 10 is detected and identified. If necessary, printer (not shown) can then be adjusted so that each label 10 is printed in the appropriate position on the label 1O.

Roll of label media is obtained 100 and placed on a printer (not shown). Labels pass by a UV light source 200 and labels and carrier reflect back a portion of the UV light. The reflected light is detected by a photosensor 300. The difference in florescence between label and carrier is detected 400. Location of the change of florescence identifies the location of the beginning of gap/end of label or the end of gap/beginning of label 500. The printer is adjusted 600 if necessary to ensure any markings, printing, logos, symbolizes or other indicate is printed in the correct position on label.

Using the florescence difference between the label and carrier allows thickness of both the label and the carrier to be reduced, thus increasing number of labels that can be wound on a roll. In addition, carrier quality can be reduced as transparency is not used. This allows use of recycled paper for carrier material.

1. A method of determining label position comprising the steps of:
obtaining a roll of label media;
passing the label media by a light source;
detecting the reflected light;
determining the location of differences in florescence; and
identifying the location of the beginning of gap/end of label and/or the end of gap/beginning of label.

2. The method of claim 1 further comprising the step of adjusting the printer and/or the label position.
